(19) United States
(12) Patent Application Publication
(10) Pub. No.: US 2005/0152556 A1
(43) Pub. Date: Jul. 14, 2005

(54) Passive surround sound adapter

(75) Inventor: G. Clark Brett, Whites Creek, TN (US)

Correspondence Address: BANNER & WITCOFF, 1001 G STREET N W, SUITE 1100, WASHINGTON, DC, 20001, US

(73) Assignee: MasonWare Partners LLC, Nashville, TN (US)

(21) Appl. No.: 11/030,995

(22) Filed: Jan. 10, 2005

Related U.S. Application Data
(60) Provisional application No. 60/534,980, filed on Jan. 9, 2004.

(51) Int. Cl. H04R 5/00; H04R 5/02

(52) U.S. Cl. 381/18; 381/19; 381/307

(57) ABSTRACT

An adapter is disclosed that converts a received stereo audio signal into a signal having more than two channels, such as a surround sound signal. For example, the adapter may convert a stereo signal to a 5.1 signal. Other types of surround sound may alternatively be generated from the stereo signal. In addition, the adapter may have no active electronic components. That is, the adapter may require no power source to perform the signal conversion other than the power inherent to the stereo signal itself. Where the adapter requires no source of power and uses relatively few parts, the adapter may be assembled in a relatively small housing.

### RELATED APPLICATIONS

This application claims priority to U.S. provisional patent application Ser. No. 60/534,980, filed Jan. 9, 2004, incorporated herein by reference as to its entirety.

### FIELD OF THE INVENTION

Aspects of the present invention are directed generally to generating surround sound from a stereo audio input, and more particularly to doing so without the need for active electronic components.

### BACKGROUND

Home theater systems have become more popular in recent years, thanks to the innovation of the DVD. Many home theater systems offer “surround sound,” which is the effect created by driving speakers placed at various locations around the listener. For example, a system may drive a left front channel speaker and a right front channel speaker (these are the conventional stereo channels) as well as a center channel speaker, a left rear channel speaker, a right rear channel speaker, and a subwoofer channel speaker. Such a setup is commonly referred to as a “5.1” type surround sound system. The term “5.1” refers to the five normal frequency channels plus the single subwoofer channel. The signal containing these six channels is known as a “5.1 signal,” which is suitable for connection to a conventional surround sound system. Other types of surround sound systems and signals are also available that use more or less channels than the 5.1 type surround sound.

To operate properly, a 5.1 surround sound system must either receive a 5.1 feed signal (e.g., from a DVD player) or synthesize a 5.1 signal from a stereo signal. There are existing “surround sound decoders” that perform such synthesis. However, such decoders use active electronic devices including integrated circuits and/or transistors.

They require a source of power in addition to the 5.1 signal. Moreover, such decoders are often not built into the lower-end systems, requiring the listener to purchase a decoder separately. Either way, such active decoders typically are expensive due to the large number of active and sophisticated electronic components contained therein. In many cases, these decoders additionally have circuitry that provides such functions as “steering” and “phase alignment” of the signals.

### SUMMARY OF THE INVENTION

In contrast to the expensive and complex decoders discussed previously, a relatively simple, passive surround sound adapter is described. The passive adapter can provide much of the same entertainment value as the sophisticated decoders at much less expense and complexity.

Aspects of the present invention are therefore directed to providing an adapter that can convert a received stereo audio signal into a signal having more than two channels, such as a surround sound signal. For example, the adapter may convert a stereo signal to a 5.1 signal. Other types of surround sound may alternatively be generated from the stereo signal.

Further aspects of the present invention are directed to providing the above-discussed adapter such that it has no active electronic components. That is, at least some embodiments of the adapter would require no power source to perform the signal conversion other than the power inherent to the stereo signal itself. Although a power source may be used to power the adapter, it is not necessary as in conventional decoders. Moreover, where the adapter requires no source of power and uses relatively few parts, the adapter may be assembled in a relatively small housing, such as a housing that is smaller than two cubic inches (e.g., about one cubic inch) in volume at very low cost.

These and other aspects of the invention will become apparent to one of ordinary skill in the art upon a reading of the following description, drawings, and the claims.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative surround sound adapter.

FIG. 2 is a schematic diagram of an illustrative surround sound adapter.

FIG. 3 is a plan view of an illustrative surround sound adapter having built-in ports.

FIG. 4 is plan view of an illustrative surround sound adapter having cables with connectors.

FIG. 5 is a plan view of another illustrative surround sound adapter having cables with connectors.

### DETAILED DESCRIPTION OF ILLUSTRATIVE EMBODIMENTS

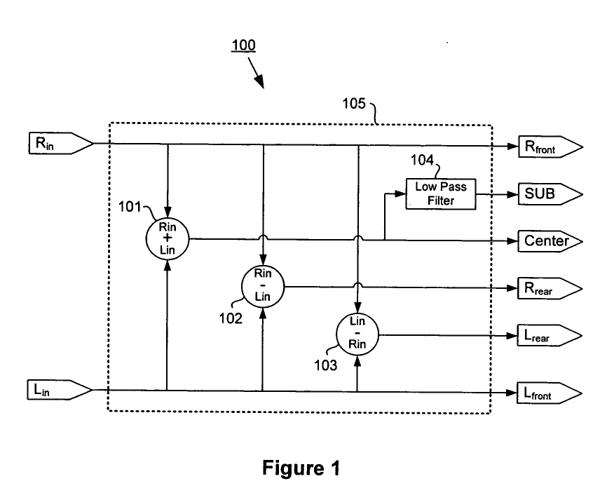

Referring to FIG. 1, an illustrative surround sound adapter 100 is shown in functional block diagram form. The adapter 100 may receive a Left Channel input (Lin) and a Right Channel input (Rin). The Lin and Rin signals may be conventional stereo channels (such as conventional line-level audio signals, approximately 1 V rms). The stereo channels may each represent audio information having frequency range of, for example, between about 20 Hz and about 20 kHz. The stereo audio signal may be from the output of some audio source device, such as a CD player, DVD player, MP3 player, radio, or video game console. As shown, the adapter 100 passes, without processing, the Lin and Rin signals to output Left Front (Lfront) and Right Front (Rfront) channels, respectively. In other words, as shown, the Lfront channel is the same as the Lin channel, and the Rfront channel is the same as the Rin channel. However, the adapter 100 may process the Lin and Rin signals if desired. The adapter 100 may further have a summing portion 101 and one or more subtracting portions 102, 103. The summing portion 101 adds the Lin and Rin channels together and outputs the resulting sum as a Center channel (Center). In addition, a Subwoofer channel (SUB) is generated by filtering the Center channel through a low-pass filter 104. The subtracting portion 102 subtracts Lin from Rin, resulting in the Right Rear channel (Rrear). The subtracting portion 103 subtracts Rin from Lin, resulting in the Left Rear channel (Lrear). Some or all of the components 101, 102, 103, 104 may be disposed in a housing 105.

In alternative embodiments, the adapter 100 may generate less than six surround sound channels (e.g., only Lfront, Rfront, Lrear, and Rrear; or only Lfront, Rfront, Lrear, Rrear, and Center; or only Lfront, Rfront, Lrear, Rrear, and SUB; or only Lfront, Rfront, and Center; or any other subcombination of channels) or more than six surround sound channels, as desired. Also, as shown, the input channels Lin and Rin are only operated on by addition, subtraction, and low pass filtering. However, other additional operations may be used, such as attenuation of one or more channels.

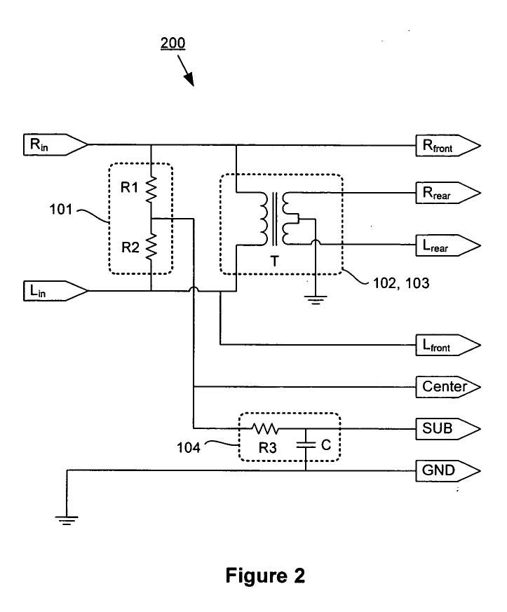

Referring to FIG. 2, an illustrative schematic diagram of a surround sound adapter 200 (which may be an implementation of the adapter 100) is shown, including references to the functional blocks discussed with regard to FIG. 1. The adapter 200 may have a housing 201 and circuitry as shown. As shown, the circuitry may include a plurality of passive components that require no power source other than the power inherent to the audio signals on the Lin and Rin input channels. In this example, the circuitry includes resistors R1, R2, and R3, a transformer T, and a capacitor C. Any of the resistors R1, R2, and R2 may be of fixed resistance or variable resistance (e.g., user-controllable resistance). In this example, the Rfront channel is the same electrical node as the Rin input channel (i.e., they are the same signal), and the Lfront channel is the same electrical node as the Lin input channel. Resistors R1 and R2 are connected in series to form a simple summing network with a summing output node disposed between resistors R1 and R2. Thus, the summing portion 101 may be illustratively implemented as the summing network of resistors R1 and R2. The Center channel is coupled to the summing node, causing the Center channel to be based on the sum of the Lin and Rin channels. Resistors R1 and R2 may be of different or the same resistance values. Preferably, resistors R1 and R1 would have the same resistance if a center balance of the overall surround sound signal is desired. In an illustrative embodiment, resistors R1 and R2 are each an approximately 1500 Ohm 0.25 Watt resistor.

As shown, the SUB channel is coupled to the Center channel via a simple resistor-capacitor R3-C Butterworth low-pass filter. Thus, R3 and C may together illustratively implement the low-pass filter 104. The Butterworth low-pass filter has a corner frequency that depends upon the values of R3 and C. For example, where R3 is an approximately 10k Ohm 0.25 Watt resistor and C1 is an approximately 0.1 uF metallized polyester capacitor, then the corner frequency would be about 158 Hz. However, the specific corner frequency is up to the designer, and resistor R3 may be a variable resistor that may be user-adjustable for changing the corner frequency. The low pass filter 104 generally passes frequencies below the corner frequency and attenuates frequencies above the corner frequency.

To implement the subtraction portions 102 and 103, the transformer T may illustratively be used. The transformer T may be any type of transformer that has at least one primary winding and at least two secondary windings. Alternatively, the transformer T may have only a single secondary winding that is center tapped. For example, the transformer T may be a Tamura TTC-174 transformer. Each of the windings (or each portion of a center-tapped winding) may be of the same or different impedances. For example, in some embodiments, each of the primary and secondary windings has an impedance of approximately 600 Ohms. The transformer T receives the Lin and Rin channels across the primary winding and outputs the Lrear channel across one of the secondary windings (or a one end of a center-tapped secondary winding) and the Rrear channel across the other secondary winding (or the other end of the center-tapped secondary winding). This causes the drive signal across the primary winding to effectively be a difference signal that is the difference between the Lin and Rin channels. Because the Lrear and Rrear channels are each connected to the outer side of their respective secondary winding, they are, in this embodiment, equal but opposite in polarity. In other words, Rrear is, in this embodiment, equal to Rin minus Lin, and Lrear is, in this embodiment, equal to Lin minus Rin. In alternative embodiments, Rrear may be proportional to, or some other function of, Rin minus Lin, and Lrear may be proportional to, or some other function of, Lin minus Rin, depending upon the relative impedances of the windings of the transformer T.

Although an illustrative adapter having only passive electrical components have been described with regard to FIG. 2, the adapter may optionally have one or more active electrical components. For instance, the adapter may have active or passive components in addition to the components shown in FIGS. 1 and 2. Or, one or more of the components shown in FIGS. 1 and 2 may be active components. For example, an amplifier may be included to amplify Lin and/or Rin. In such embodiments, one or more of the outputs may be amplified. Depending whether an amplifier is used and if so, the type of amplifier, the Lfront channel may be equal to the Lin channel and the Rfront channel may be equal to the Rin channel, or the Lfront channel may be amplified and proportional to the Lin channel and the Rfront channel may be amplified and proportional to the Rin channel. Also, one or more resistors, and/or resistance inherent to wiring, may be present between the Lin channel and the Lfront channel, and between the Rin channel and the Rfront channel, causing the Lfront and Rfront channels to also be proportional to, but lower in amplitude than, their respective input channels.

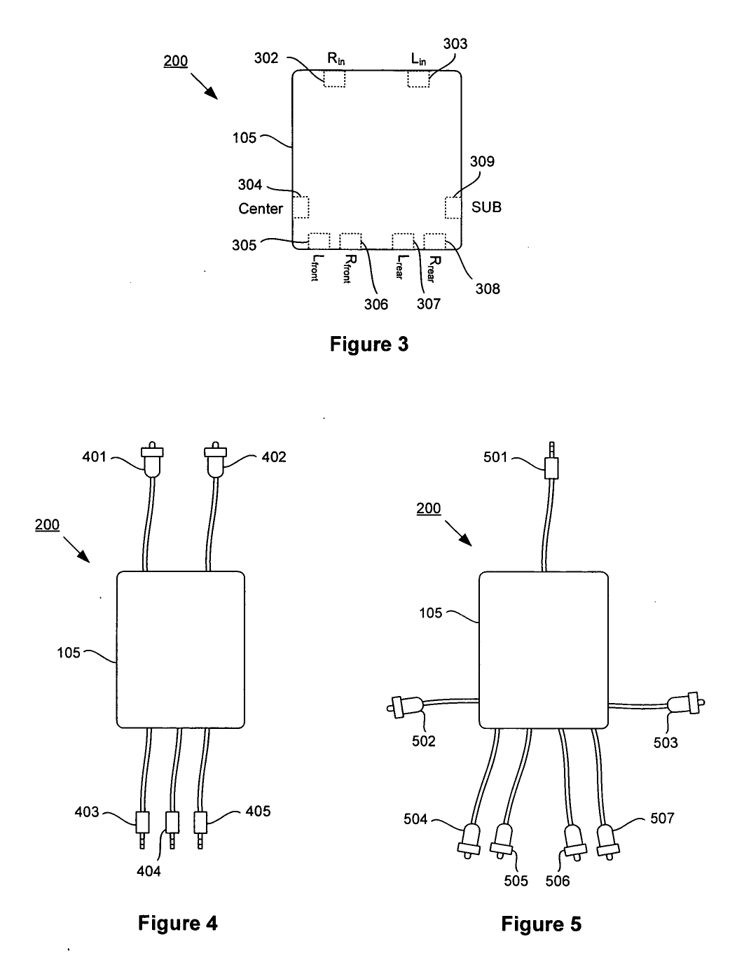

Referring to FIG. 3, the adapter 200 may be partially or fully housed in the housing 105, such as a plastic or metallic case. The housing 105 may be relatively small and portable. For example, the housing 105 may be smaller than two cubic inches in volume, or even smaller, such as about one cubic inch in volume. Also, the housing 105 may include a plurality of input and/or output ports, such as an Rin input port 302 for receiving the Rin channel, a Lin input port 303 for receiving the Lin channel, a Center port 304 for outputting the Center channel, a Lfront port 305 for outputting the Lfront channel, an Rfront port 306 for outputting the Rfront channel, a Lrear port 307 for outputting the Lrear channel, a Rrear port 308 for outputting the Rrear channel, and/or a SUB port 309 for outputting the SUB channel.

The ports 302-309 may be connected to the exterior of the housing 105, or partially or fully disposed within the housing 105 as indicated by the broken lines representing the ports 302-309. In addition, the ports 302-309 may be flush with the exterior of the housing 105, recessed into the exterior of the housing 105, or extending from the exterior of the housing 105. The ports 302-309 may be any type of ports such as coaxial RCA-type connectors (such as port 401 in FIG. 4), headphone-type ⅛ inch miniplug connectors/jacks (such as port 403 shown in FIG. 4), spring-loaded wire connectors, twist or screw-on connectors, or any other type of electrical connectors, male or female. The ports 302-309 may each be physically separate from one another. Alternatively, some or all of the ports 302-309 may be physically combined into one or more physical ports. For example, multiple channels may be combined onto a single physical port that has multiple electrical conductors, such as a single 5-pin DIN connector or the like, where each channel uses a different conductor of the 5-pin DIN connector.

Referring to FIG. 4, the adapter 200 may have one or more ports 401, 402, 403, 404, 405 that are coupled to the end of a cable instead of being part of the housing 105. The cables may extend from the housing 105 and terminate at the respective ports 401-405. The cables may or may not be shielded. If shielded, the shields may be electrically connected to the common ground point shown in FIG. 1.

Further, the adapter 200 may have a combination of ports configured as shown in both FIGS. 3 and 4 (i.e., where some ports are part of the housing 105 or directly connected to the housing, and other ports are coupled to the housing 105 via a cable). FIG. 4 is also an example of how multiple channels may be combined on a single port. The input channels in the shown embodiment are received on separate ports; the Lin channel is received on port 401, and the Rin channel is received on port 402, which is physically separate from port 401. However, port 403 may output, for example, both the Lfront and the Rfront channels, whereas port 404 may output both the Center and SUB channels and port 405 may output both the Lrear and Rrear channels. In the shown embodiment, ports 403, 404, and 405 are each stereo headphone miniplug jacks that each have three separate electrical conductors. Thus, in this embodiment, each jack may be used to carry two channels and ground, one on each of the conductors.

FIG. 5 shows another example of the adapter 200, in this instance configured to combine the input channels Lin and Rin on a single port 501 but to output each of the output channels Lfront, Rfront, Lrear, Rrear, Center, and SUB on their own dedicated ports 502-507. In this example, the input port 501 is a stereo headset miniplug jack having three separate electrical conductors. Two of the conductors are each used for a different one of the input channels Lin and Rin, and the third conductor is used for ground.

Thus, a convenient, power efficient, and portable surround sound adapter has been disclosed. While illustrative systems and methods as described herein embodying various aspects of the present invention are shown by way of example, it will be understood, of course, that the invention is not limited to these embodiments. For example, the circuitry of the surround sound adapter need not be in a separate dedicated housing, but may instead be incorporated into another audio component such as an audio amplifier and/or stereo receiver. Also, each of the elements of the aforementioned embodiments may be utilized alone or in combination with elements of the other embodiments.

1. An apparatus for converting stereo audio into surround sound audio, comprising:
an input portion configured to receive a left stereo input channel and a right stereo input channel;
a summing portion configured to generate a first output channel based on a sum of the left stereo input channel and the right stereo input channel;
a subtraction portion configured to generate a second output channel and a third output channel each based on a difference between the left stereo input channel and the right stereo input channel, the second and third output channels being different from each other;
a stereo portion configured to output a fourth output channel based on the left stereo input channel and a fifth output channel based on the right stereo input channel; and
an output portion configured to output the first output channel, the second output channel, the third output channel, the fourth output channel, and the fifth output channel.

2. The apparatus of claim 1, further including a low pass filter configured to filter the first output channel to generate a sixth output channel, the output portion further configured to output the sixth output channel.

3. The apparatus of claim 1, wherein the fourth output channel is the same as the left stereo input channel and the fifth output channel is the same as the right stereo input channel.

4. The apparatus of claim 1, wherein the fourth output channel is proportional to the left stereo input channel and the fifth output channel is proportional to the right stereo input channel.

5. The apparatus of claim 1, wherein the second and third output channels are equal in value but opposite in polarity.

6. The apparatus of claim 1, further including a housing containing the summing portion the subtraction portion, and the stereo portion, the input portion carrying the left stereo input channel and the right stereo input channel into the housing, the output portion carrying the first, second, third, fourth, and fifth output channels out of the housing.

7. The apparatus of claim 6, wherein the housing is smaller than two cubic inches in volume.

8. The apparatus of claim 1, wherein the summing portion, the subtraction portion, and the stereo portion consist only of passive components.

9. The apparatus of claim 1, wherein the summing portion is configured to sum a voltage of the left stereo input channel with a voltage of the right stereo input channel.

10. The apparatus of claim 9, wherein the subtraction portion is configured to generate a second output channel and a third output channel each based on a difference between a voltage of the left stereo input channel and a voltage of the right stereo input channel, the voltages of the second and third output channels being different from each other.

11. An apparatus for converting stereo audio into surround sound audio, comprising:
a left stereo channel input;
a right stereo channel input;
a first resistor and a second resistor coupled in series, the left and right stereo channel inputs being coupled together by the first and second resistors, a floating potential node being defined between the first and second resistors;
a transformer having a primary winding, a first secondary winding, and a second secondary winding, the left and right stereo channel inputs being coupled across the primary winding, the first and second secondary windings being coupled together at a first fixed potential node;
a first output coupled to the left stereo channel input;
a second output coupled to the right stereo channel input;
a third output coupled to a side of the first secondary winding opposite the common fixed potential node;
a fourth output coupled to a side of the second secondary winding opposite the first fixed potential node; and
a fifth output coupled to the floating potential node.

12. The apparatus of claim 11, further including:
a third resistor having one side coupled to the floating potential node and the other side coupled to a sixth output; and
a capacitor coupled between the sixth output and a second fixed potential node.

13. The apparatus of claim 12, wherein the first and second fixed potential nodes are at a same potential.

14. The apparatus of claim 11, further including a housing containing the first resistor, the second resistor, and the transformer.

15. The apparatus of claim 14, further including an input configured to carry a left stereo channel to the left stereo channel input and a right stereo channel to the right stereo channel input, the input configured to carry the left and right stereo channels into the housing.

16. The apparatus of claim 14, wherein the left stereo channel input and the right stereo channel input are each configured to carry a respective signal into the housing.

17. The apparatus of claim 14, wherein the housing is smaller than two cubic inches in volume.

18. The apparatus of claim 11, wherein the apparatus consists only of passive components.

19. An adapter for converting stereo audio into surround sound audio, comprising:
a housing containing only passive electrical components, including:
a left stereo channel line;
a right stereo channel line;
a first resistor and a second resistor coupled in series, the left and right stereo channel lines being coupled together by the first and second resistors, a floating potential node being defined between the first and second resistors;
a transformer having a primary winding, a first secondary winding, and a second secondary winding, the left and right stereo channel lines being coupled across the primary winding, the first and second secondary windings being coupled together at ground;
a first output coupled to the left stereo channel line and configured to output a signal provided on the left stereo channel line;
a second output coupled to the right stereo channel line and configured to output a signal provided on the right stereo channel line;
a third output coupled to a side of the first secondary winding opposite ground;
a fourth output coupled to a side of the second secondary winding opposite ground;
a fifth output coupled to the floating potential node;
a third resistor having one side coupled to the floating potential node and the other side coupled to a sixth output; and
a capacitor coupled between the sixth output and ground.
